(19) United States
(12) Patent Application Publication
(10) Pub. No.: US 2006/0224766 A1
(43) Pub. Date: Oct. 5, 2006

(54) Operating room communication bus and method

(76) Inventors: Donald W. Malackowski, Schoolcraft, MI (US); Chunwu Wu, Kalamazoo, MI (US)

Correspondence Address: MCCRACKEN & FRANK LLP, 200 W. ADAMS STREET, SUITE 2150, CHICAGO, IL, 60606, US

(21) Appl. No.: 11/096,944

(22) Filed: Mar. 31, 2005

(51) Int. Cl. G06F 15/16

(52) U.S. Cl. 709/233

(57) ABSTRACT

An operating room system that enables real time control between applications connected to a backbone within the operating room so that these devices can effectively communicate and interact in real time.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

This invention relates to a communication bus and method for use in a surgical operating room. More particularly, this invention relates to a communication bus and method to enable various devices used in a surgical operating room to communicate efficiently and I real time.

2. Description of the Background of the Invention

The development of high speed data links has made it possible to interlink a variety of devices to form a cohesive network to accomplish a desired result. Often, the speed of communication over the data link has made true real time interaction problematic. In certain applications, some delay in executing instructions can be tolerated. But in other time critical applications, including the use of a data link in a health care environment, the user expects real time control of peripheral equipment that may be controlled by a computer, control device or the like.

The high speed serial bus topology set out in the various IEEE-1394 standards offers a backbone within which to execute real time instructions in distributed devices connected to the serial bus. While systems that use the IEEE-1394 standards approach real time control and interaction, these systems fall short of the close real time interactions necessary for use in time critical applications such as in a hospital surgical operating room.

There is a need for a communications linkage or bus that allows various devices and the applications that run on these devices to truly operate as a single unit. This includes the need to assist in the setup and customization of various devices and applications so that the user sees a seamless system that can be customized to the users preferences and specifications. In an operating room environment, many surgeons will have a slightly different way of approaching a particular procedure. A system that will assist in the setup of the devices to operate in the fashion familiar to the surgeon will save time and assist in a more optimum outcome for the patient.

### SUMMARY OF THE INVENTION

According to one embodiment of the present invention an integrated system for operating room management of multiple devices connected together by a bus structure comprises a first device usable in a surgical operating room that has a real time communications port connected to the bus structure; and a first application running on the first device. The system also has a second device usable in a surgical operating room that has a real time communications port connected to the bus structure and a second application running on the second device. The bus structure enables the first device to communicate in real time with the second device and also to communicate in real time with other devices that are connected to the bus structure.

A further embodiment of the present invention comprises a method for providing real time communication between multiple devices in an operating room environment. The method comprises the steps of connecting a first device to the bus structure using a real time communications link and having an application program running on the first device. The method also includes the steps of connecting other devices to the bus structure using a real time communications link and each other device having an other application program running on the other device. The method further includes the steps of passing packets of data through the real time communications link from the first application to the other applications and to enable the first application to control at least one other application or at least one other device.

A still further embodiment of the present invention comprises an integrated system for managing applications within an operating room environment that includes a bus structure that has a node connected to the bus structure and a first device connected to the node that includes a first application program running on the device. The system further includes a plurality of other nodes connected to the bus structure and other devices connected to each of the nodes, each device having an other application running on the other device. In addition, the system includes an API that enables real time communication between the first application and the other applications and where the API manages the connection of the other applications to the bus structure, the negotiation between the first application and the other applications and the sending and receiving of data between the first application and the other applications.

### BRIEF DESCRIPTION OF THE DRAWINGS

FIG. 1 is schematic view of a topology of a data link useful with one embodiment of the present invention;

FIG. 2 is a schematic view of a typical 1394 compliant device and application running thereon useful in various embodiments of the present invention;

FIG. 3 is a partial listing of commands for one embodiment of the present invention;

FIG. 4 is a partial listing of responses to commands for one embodiment of the present invention;

FIG. 5 is a generic structure of the commands, responses, and messages of one embodiment of the present invention;

FIG. 6 is a flow diagram of one aspect of an embodiment of the present invention;

FIG. 7 is a flow diagram of a further aspect of an embodiment of the present invention; and

FIG. 8 is a flow diagram of a still further aspect of an embodiment of the present invention.

### DETAILED DESCRIPTION OF THE PREFERRED EMBODIMENTS

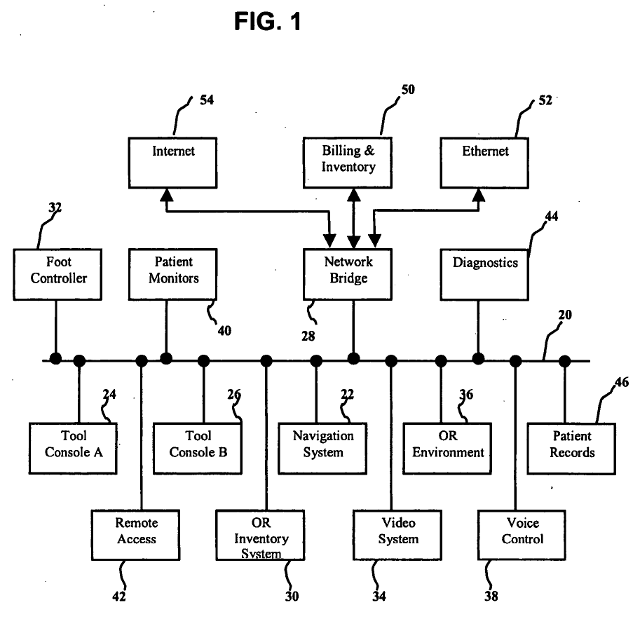

Referring to FIG. 1, a typical bus structure 20 will have a number of devices connected thereto. These include a personal computer running a surgical navigation system 22, a tool console 24, a second tool consol 26, a network bridge 28, a personal computer running a operating room inventory system 30, a foot controller 32, a video system 34, an environmental system 36 for the operating room, a voice control device 38, a patient monitoring device 40, a remote control bridge 42, diagnostic equipment 44, and a patient record system 46. Also connected to the bus structure 20 through the network bridge 28 are a computer running a billing and inventory system or systems 50, an external network 52, here identified as an Ethernet network, and a connection to the internet 54. While any suitable bus structure 20 can be used, it is preferred that the bus structure 20 is an IEEE-1394 compliant serial bus. By an IEEE-1394 compliant bus is meant any bus that complies with any of the applicable IEEE standards for serial buses such as the IEEE 1394-1995. IEEE-1394a, and IEEE-1394b standards and any successor standards to these standards. As indicated above, the specific topology of the bus may include certain devices connecting through other devices. For instance, the foot controller 32 may connect to the bus structure 20 through the tool console 24.

In one embodiment of the present invention, the data packets passing in the bus structure 20 will enable each device connected to the bus structure 20 to communicate directly with any other device connected to the bus structure 20. This will also enable the applications that may be running on a particular device to directly communicate with applications running on an other device without passing through an intermediary device processing unit. Often the data that will be transmitted through the bus structure 20 will be high bandwidth data, such as data that is transferred at greater than 100 mbs. This topology enable real time control to co-exist on the bus structure 20 with the transfer of large volumes of data. Furthermore, the bus structure 20 enables distributed processing of the data so that no single device connected to the bus structure 20 is responsible for processing all the data that passes through the bus structure 20. In addition, each device is responsible for managing that own device's data flow. On advantage of the present system is that a single device may communicate directly with one or more devices that are also connected to the bus structure 20 in real time. In addition, because of the nature of the bus structure 20, each device, if needed, will be able to have real time access at a predefined fixed interval, typically no greater than every 1 ms.

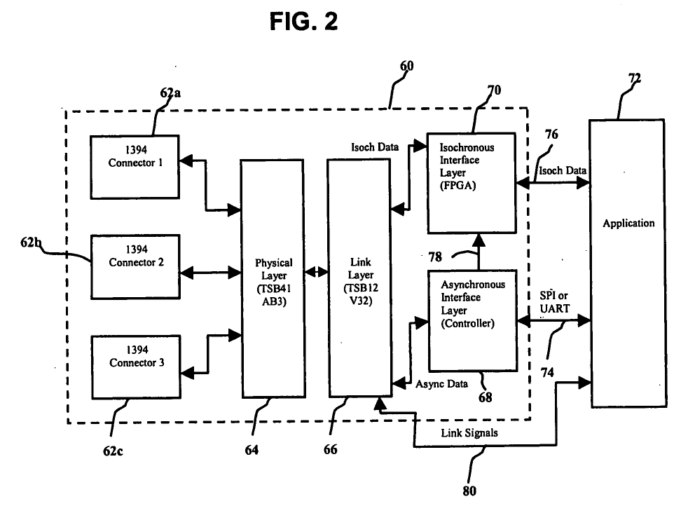

FIG. 2 shows a schematic of a device 60 suitable for connection to a 1394 bus. The device 60 will typically include multiple 1394 connectors 62a, 62b, and 62c to connect the device 60 to the bus structure 20. The connectors 62a-c are connected to a PHY integrated circuit 64 that is connected to a link integrated circuit 66. For many IEEE-1394 compliant devices only the PHY IC 64, and the connectors 62a-c are constantly powered. The PHY IC 64 in these prior devices are either powered directly by the bus structure 20 or by some power scheme such that the device 60 constantly maintains power to the PHY IC 64 even is the rest of the device 60 has been powered down.

The link IC 66 is then connected to an asynchronous interface 68 and to an isochronous interface 70. Both the asynchronous interface 68 and the isochronous interface 70 are capable of communicating with an application 72 that is running on the device 60. The connectors 62a-c, the PHY IC 64, the link IC 66, the asynchronous interface 68, and the isochronous interface 70 are all considered to be part of the communication layer of the device 60. In the preferred embodiments of the present invention, all elements of the communication layer are powered at all times. The power may come directly from the bus structure 20, or if the device 60 has an optional power supply switched on, the communication layer can be powered by the optional power supply. This enables the power manager to reassign power to be used by other devices that require power from the bus structure 20. At the simplest level, a consumer device, the PHY IC 64 , the link IC 66, the asynchronous interface 68, and the isochronous interface 70 all have their VDD terminals connected to the 3.3 volt power that is supplied by the bus structure 20 to the PHY IC 64. The application 72 is considered as the application layer.

The communication between the application 72 and the asynchronous interface 68 and the isochronous interface 70 is bi-directional as represented by arrows 74 and 76. The asynchronous interface 68 is also connected to and capable of communicating with the isochronous interface 70 represented by arrow 78. In certain preferred embodiments, the asynchronous interface 68 will program or control the isochronous interface 70. There is also a direct communication between the link IC 66 and the application 72, represented by arrow 80. In certain preferred embodiments, this direct communication between the link IC 66 and the application 72 is desirable.

As noted previously, in a preferred embodiment, the communication layer of the device 60 always will be powered. The power is either provided directly by the bus structure 20 or by a direct power source within or external to the device 60. If this external power source is removed, then the bus structure 20 will thereafter power the communication layer of this device 60. Maintaining the power to the link IC 66, the asynchronous interface 68 and the isochronous interface 70 will result in two very important benefits. First, the bus structure 20 will not perform a bus reset every time an application layer is switched off or on. The second benefit is that the asynchronous interface 68 can also include software to control the power to the application layer. This enables the power manager to send a power off or power on command to the communication layer of a particular device to switch power on or off for a particular application layer. This enables the power manager to dynamically reconfigure the applications connected to the bus structure 20 based on current needs and to do so without performing a bus reset.

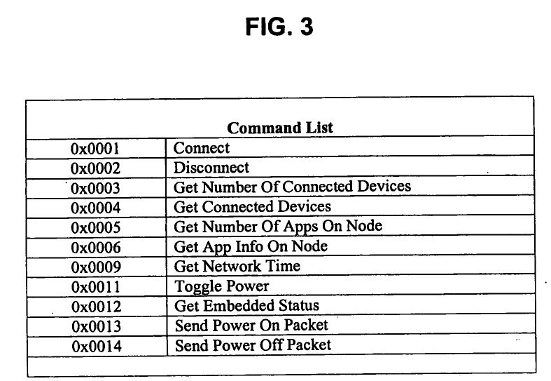

FIG. 3 is a partial listing of commands that certain applications running on selected devices attached to the bus structure 20 can send to any of the other applications running on other devices attached to the bus structure 20. Certain devices, such as the foot controller 32 or the voice controller 38 may only be capable of responding to commands and can initiate or send only a subset of commends, such as the Connect and Disconnect commands.

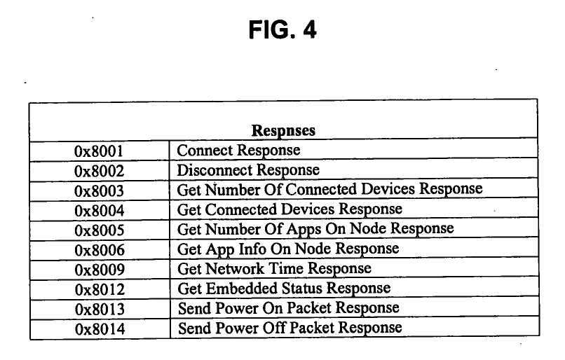

FIG. 4 is a listing of responses that all applications running on devices attached to the bus structure 20 will return in response to the corresponding commands listed in FIG. 3. For instance, an application will send the connect response in response to receiving a connect command from an application.

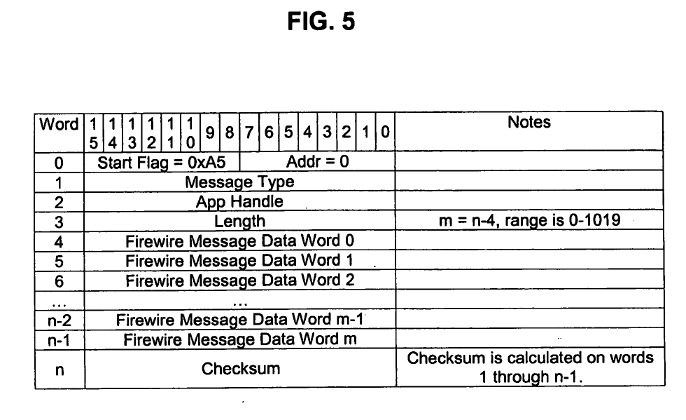

As indicated earlier, when an application wants to communicate with other applications over the bus structure 20, the application must first register itself so that other applications know how to contact that application and send messages and commands to that application. All commands, responses and unsolicited messages are in the format as shown in FIG. 5. Each message is made up of n words where word 0 is always a start flag and the address equal to 0. The last word n is always a checksum that is calculated on all words 0 through n−1. The checksum allows the use of 0xA5 in the data words 0 through m. The system will confirm that the start flag 0xA5 will always end with a valid checksum as the last word of that message. The word 1 is the message type. The message types for each command, response and message are shown in FIGS. 2-4. The word 2 is the App Handle. This is the identity of the particular application that is either sending the command, the application to which the response is directed, or the value 0xFFFE that indicates that a particular application is connecting to the bus structure 20 and needs an App Handle. The word 3 is the length of the message m that is equal to n−4. Words 4 to n−1 contain the data of the message. As will be discussed later, certain commands, and messages will have a length equal to zero meaning that the message contains no data.

The Connect command is used when an application first connects to the bus structure 20. Because the application does not yet have an App handle, the Connect command will always include the App Handle 0xFFFE. The data in the Connect command will include the maximum packet size the application can handle and a description of the application. The Connect response will include the value of the App Handle for the application, addressing information for the application, the EUID, the unique ID, and the node ID. The response also can include revision data about the bus structure 20 and status information about the device on which the application is running, such as if the device is capable of isochronous communication. In addition to the checksum, the response will also include information about the application to confirm the identity of the application that is connecting to the bus structure 20.

The Disconnect command is used to remove an application from the bus structure 20. If this command is successful, the buffers allocated to the application are freed up and made available for use by other applications. The response to a Disconnect command has a single data word that indicates if the disconnection is successful.

The Get Number of Connected Devices command, the Get Connected Devices commands and the appropriate responses enable an application to determine he identity and location of other devices on the bus structure 20. The Get Number command will often use a filter to limit the response to those devices that match the filter description. It is possible to not use a filter and return the number of all devices connected to the bus structure 20. The use of a filter will limit the traffic on the bus structure 20 and the identity of the filter can be based on a database of acceptable devices with which a particular application can effectively communicate. The response returns the number of devices that are attached to the bus structure 20 that match the filter used. The Get Connected Devices command will return the device descriptions for the number of devices identified by the Get Number command response. The response will include device information.

The next set of commands and responses is similar to the above except they ask for the number and identity of the applications that are running on a particular node or device. The response to the Get Number of Applications command will be the number of applications that are running or registered on the device identified in the command. This number may be zero if no applications are currently running on that device. The Get Application Information command will get information about the identity and characteristics of the applications that are registered or running on a device or node.

The Get Network Time command is used by applications as part of the application maintaining time synchronization. Because there is some delay as the time pulse travels along the bus structure 20, there can be a slight skew of the network time along the bus structure 20. The maximum allowable skew is 125 microseconds. This is the length of the periods used by the IEEE-1394 bus specification. From a human perspective, the maximum delay of 125 microseconds is acceptable for a real time application for an operating room environment because the maximum 125 microsecond delay is not perceptible to a human user.

The Toggle Power command is used to toggle the power enable and reset enable pins. This message includes data to indicate the length of time the application is to be disconnected from the bus structure 20. This command can be sent to a single application or to all applications. In response to this command the power enable pin becomes inactive and the reset enable pin is active. The asynchronous interface 68 controls these pins. After the period of off time specified in the command the reset enable pin becomes inactive and the power enable pin is active. There is no response message to this command.

The Get Embedded Status command is a request to a specific node to indicate the current status of the target embedded node. In the current configuration, this command will return a response that indicates the power status of the target node. One flag will indicate the presence of an optional power jack to supply power to the device. A second flag will indicate if the device has been given permission to draw power from the bus structure 20. All devices will connect to the bus structure 20 assuming that they do not have permission to draw power for the application layer of the device.

The Send Power On Packet, Send Power Off Packet, and the appropriate responses enable the power manager attached to the bus structure 20 to send commands to device or node connected to the bus structure 20 to either grant permission for the node to draw power from the bus structure 20 or to revoke a previously granted permission to draw power.

In addition, there are also messages that manage the flow of data through the isochronous and asynchronous channels. These commands are typical of any communication over an IEEE-1394 serial bus and will not be further discussed.

There are unsolicited messages that indicate if an error has been generated as a result of any of the above commands. The message will return an error code that will assist in determining the cause of the error. The Bus Reset message is broadcast to all nodes whenever a bus reset occurs on the bus structure 20. This message will indicate if any isochronous channels have been reacquired after the reset.

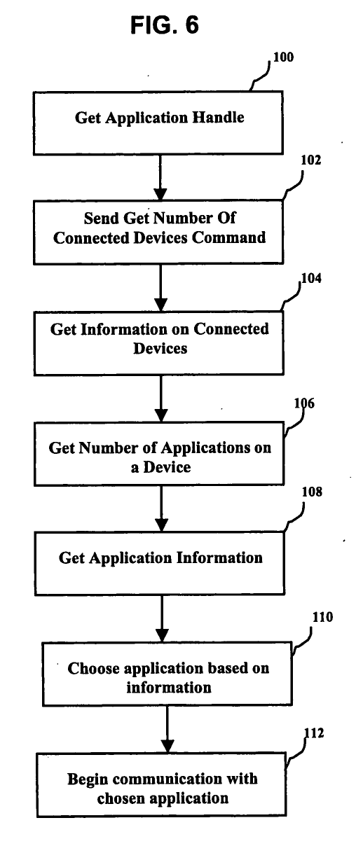

FIG. 6 is a flow diagram that steps though the process of connecting an application to the bus structure 20. A block 100 gets the application handle using the Connect command described above. The application handle is returned as part of the command response. Next, a block 102 will send the Get Number of Connected Devices command. As note previously, this command will return the number of devices or nodes connected to the bus structure 20 that match the optional filter included with the command. Once the system knows the number of appropriate connected devices, a block 104 will then obtain the information about the connected devices using the Get Information of Connected Devices command. The return message will provide detailed information about the queried devices. Control then passes to a block 106 that determines the number of applications that are running on a particular device selected from the devices identified by the block 104. After the response is received relative to the query for the number of applications by the block 106 control then passes to a block 108 that determines the information for each application identified by the block 106. Control then passes to a block 110 that chooses a particular application based upon the parameters of the query and the returned information. Control then passes to a block 112 that begins communication with the application chosen by the block 110.

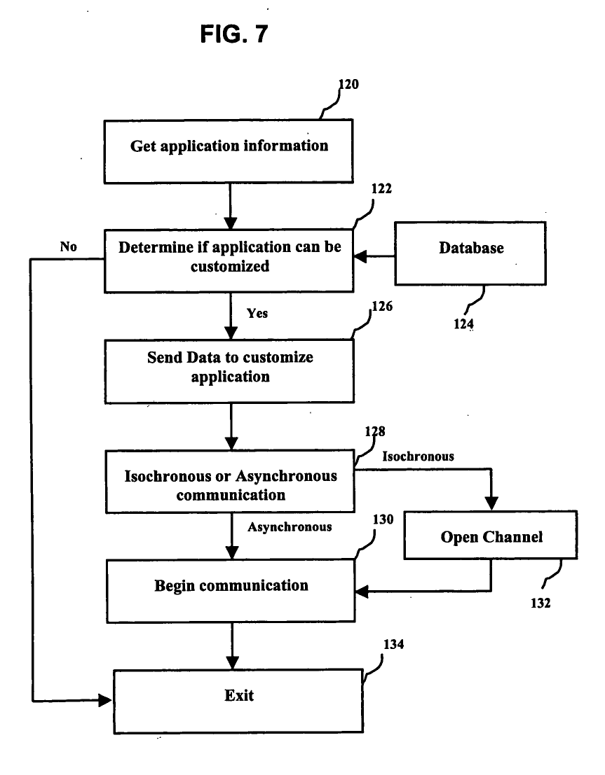

FIG. 7 sets out a flow diagram of the interaction between two applications where one application seeks to customize the second application to work more closely with the first application. A block 120 receives the application information in the format of FIG. 12. Based on this information a block 122 will determine if the application identified by the block 120 can be customized. The block 122 may also receive information from a database 124 that includes devices and applications that can work together or the block 122 may also be able to make the customization decision based solely on the information from the block 120. If the block 122 determines the target application cannot be customized, the routine branches via the No branch to a block 134 and exits.

If the target application is subject to customization, the control passes via the Yes branch to a block 126 that then sends the appropriate data to the target application to customize the application so that the first and the send applications can work together in a seamless environment. Typically, this information is sent in asynchronous form to the target application. Once the applications have been customized the system will then pass control to a block 128 that determines the mode of communication between the two applications. The bus structure 20 will enable both isochronous and asynchronous communication. The block 128 will determine if the ongoing communication between the two applications will be in isochronous or asynchronous mode. If the mode of communication is asynchronous, control passes via the asynchronous branch to a block 130 that begins communication using the commands described above. If the block 128 determines that the communication is isochronous control passes to a block 132 that opens a channel for isochronous communication. Once the block 132 opens the channel then control passes to the block 130 and communication will start. As this point the routine will then exit at the block 134.

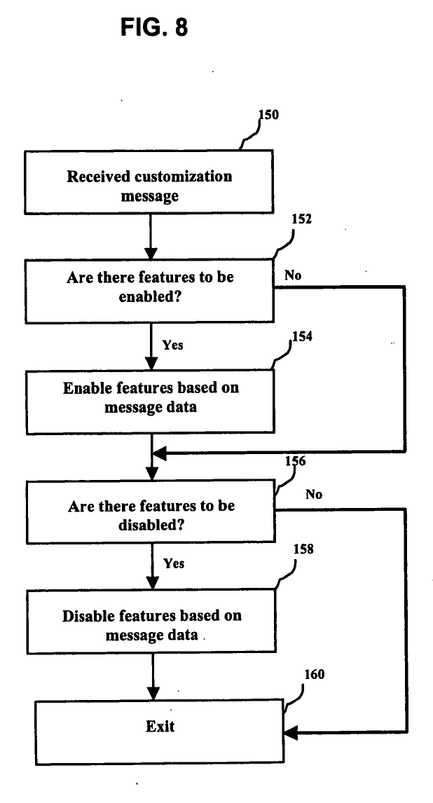

FIG. 8 is a flow diagram of an overview of the customization process. It should be noted that the customization can be based in whole or in part on the user preferences. For instance, in a surgical environment, the surgeon may have a preference for the equipment to be setup and configured in a particular manner. The flow diagram of FIG. 8 will facilitate this setup and configuration process. The process begins at a block 150 that receives the customization message and data. Based on the message received by the block 150 control passes to a block 152 that determines if there are features in the receiving application to be enabled. If the instruction requests enablement of specific features or capabilities of the receiving application and if the receiving application can be so customized or enabled, the block 152 will branch via the Yes branch to a block 154 that enables the appropriate features based on the message instructions. For instance, the user may request that a foot controller is set to a certain level of sensitivity. If the foot controller can be so programmed, the block 154 will set the appropriate maximum output and the increment so that the customization desired by the user can be accomplished. After the customization has been accomplished, control passes to a block 156. If the instructions received by the block 150 do not request enablement of any features or if the application has no features that can be enabled, the block 152 will branch via the No branch to the block 156.

The block 156 determines if there are any features or capabilities of the target or receiving application to be disabled based on the instructions received by the block 150. If there are instructions to disable certain features and if features can be disabled, control will pass to a block 158 that performs the feature disabling. For instance, for a particular surgical approach, certain menus or screens are not needed and it is desirable to bypass these menus or screens so that there is minimal distraction by the user in the desired flow of the procedure. After the block 158 disables the appropriate elements control pass to a block 160 that exits the routine. If the block 156 determines there are no appropriate features to be disabled, the block 156 will branch via the No branch to the block 160 and exit.

The data structures and logic elements described above can be carried out in any of the known programming languages, such as C++ and the like. The code also can be loaded into certain devices using removable media such as CD's or can be embedded in firmware that may also be updateable.

I/We claim:

1. An integrated system for operating room management of multiple devices connected to a single bus structure comprising:
a first device usable in a surgical operating room having a real time communications data port connected to the bus;
a first application program running on the first device;
a second device usable in a surgical operating room having a real time communications data port connected to the bus;
a second application program running on the second device;
wherein the bus structure enables the first device to communicate in real time with the second device and also to communicate in real time with other devices that are connected to the bus structure.

2. The integrated system of claim 1 wherein the first device communicates directly with other devices that are connected to the bus structure in real time.

3. The integrated system of claim 1 wherein the first device simultaneously communicates with multiple other devices that are connected to the bus structure in real time.

4. The integrated system of claim 1 wherein the bus carries high bandwidth data communication.

5. The integrated system of claim 4 wherein as the data is transferred at greater than 100 mbs.

6. The integrated system of claim 1 wherein each device that is connected to the bus structure has real time access at a predefined fixed interval.

7. The integrated system of claim 6 wherein the predefined fixed interval no greater than every 1 ms.

8. The integrated system of claim 1 wherein the bus can transfer large volumes of data.

9. The integrated system of claim 8 wherein real time communication co-exists with the transfer of large volumes of data.

10. The integrated system of claim 1 wherein each device that is connected to the bus structure manages that device's own data flow.

11. The integrated system of claim 10 wherein no single device is responsible for processing all the data.

12. The integrated system of claim 1 wherein each device that is connected to the bus structure may be added to or removed from the bus during bus operation.

13. The integrated system of claim 12 wherein the bus structure dynamically reconfigures as devices are added or removed.

14. The integrated system of claim 1 wherein the bus structure is capable of supplying power to any device that is connected to the bus structure.

15. The integrated system of claim 1 wherein any device each device that is connected to the bus structure can supply power to the bus structure.

16. The integrated system of claim 1 wherein the first application program provides data to the second application program and also provides data to a third application program running on a third device connected to the bus structure.

17. The integrated system of claim 16 wherein the first application program first identifies specific application programs connected to the bus structure that can interact with the first application program.
The integrated system of claim 1 wherein the first application program provides data to the second application program and also provides data to a third application program running on a third device connected to the bus structure.

18. The integrated system of claim 1 wherein the bus is an IEEE-1394 bus.

19. The integrated system of claim 19 wherein the first device has a communications layer that can be powered from the bus when power to the first device is switched off.

20. The integrated system of claim 1 wherein the second application program is contained in a read only memory device associated with the second device.

21. The integrated system of claim 1 wherein the first device is a computer and the first application program is a navigation system.

22. A method of providing real-time communication between multiple devices connected together by a bus structure in an operating room environment, the method comprising the steps of:
connecting a first device to the bus structure using a real time communications link and having an application program running on the first device;
connecting other devices to the bus structure using a real time communications link and each other device having an other application program running on the other device; and
passing packets of data through the real time communications links from the first application to the other applications, to enable the first application to communicate with the other application programs and to enable the first application to control at least one other application or at least one other device.

23. The method of claim 23, wherein the first device is a computer.

10. The method of claim 23, wherein the other application program is contained on read only memory.

25. The method of claim 23, wherein the method also includes the step of determining that the first device can interact with the other device.

26. The method of claim 23, wherein the method also includes the steps of determining the power status of a device and controlling a flow of power to that device.

27. The method of claim 23, wherein the packets of data are passed directly from the first application to the other application.

28. The method of claim 23, wherein the first application simultaneously communicates to multiple other applications at the same time.

29. The method of claim 23, wherein the packets of data are passed at greater than 100 mbs.

30. The method of claim 23, wherein each device manages that devices own data flow.

31. The method of claim 23, wherein no single device processes all the data

32. An integrated system for managing multiple devices in real time within an operating room environment comprising:
a bus structure that has a first node connected to the bus structure;
a first device connected to the first node, the first device running a first application program;
a plurality of other nodes connected to the bus structure;
other devices connected to each of the other nodes, each device having an other application program running on the other device; and
an API to enable real time communication between the first application and the other applications, wherein the API manages the connection of the other applications to the bus structure, the negotiation between the first application and the other applications and the sending and receiving of data between the first application and the other applications.

33. The integrated system of claim 33, wherein the first device queries each other device as it is connected to the bus structure to determine if the first device can interact with the other device.

34. The integrated system of claim 33, wherein the first application program customizes the other application program and wherein the first application program controls the other application program running on the other device.

35. The integrated system of claim 33, wherein the API enables the control of power to the first device and the other devices.

36. The integrated system of claim 36 wherein the first device has a communications layer that can be powered from the bus when power to the first device is switched off.

37. The integrated system of claim 33 wherein the bus structure is an IEEE-1394 bus.

38. The integrated system of claim 33 wherein the other application program is contained in a read only memory device associated with the other device.

39. The integrated system of claim 33 wherein the first device communicates directly with other devices that are connected to the bus structure in real time.

40. The integrated system of claim 33 wherein the first device simultaneously communicates with multiple other devices that are connected to the bus structure in real time.

41. The integrated system of claim 33 wherein the bus carries high bandwidth data communication.

42. The integrated system of claim 41 wherein as the data is transferred at greater than 100 mbs.
